(19) United States
(12) Patent Application Publication
(10) Pub. No.: US 2004/0027775 A1
(43) Pub. Date: Feb. 12, 2004

(54) Electromagnet arragement for a switch

(76) Inventor: Volker Lang, Bonn (DE)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/399,344

(22) PCT Filed: Jul. 27, 2002
(86) PCT No.: PCT/EP02/08402

(30) Foreign Application Priority Data
Aug. 17, 2001 (DE) 101405596

(51) Int. Cl. H01H 47/00

(52) U.S. Cl. 361/160

(57) ABSTRACT

The invention relates to an electromagnet arrangement for a switch (contractor), comprising a main magnetic circuit (MK1) consisting of a magnet yoke (10) and a magnet armature (60) impinged upon by a readjusting device (36), a contact apparatus of said switch which actively co-operates with the magnet armature (60), at least one permanent magnet for the production of a retaining force arranged in the main magnet circuit (MK1), at least one exciter coil (30,32) which is associated with the magnet yoke (10) and which is used to produce the attraction force for the magnet armature (60), and a control circuit, whereby a secondary shunt circuit (MK2) is formed parallel to the main magnet circuit (MKI), said shunt circuit also being able to be closed via the magnet armature (60) and comprised of two pole limbs (11) and a yoke arch (24) arranged on the magnet armature (10) opposite the pole surfaces which is interrupted by a remanence gap (25).

The present invention relates to an electromagnet system for a switch, in particular for a switch contactor, according to the preamble of claim 1.

Electromagnetic switch contactors are usually dimensioned electrically and magnetically so that little electric power is to be applied in the holding state of the magnet armature (e.g., German Patent Application 195 26 038 A1). This is recommended because devices of this type are in the holding state most of their operating time. Power consumption in the holding state has the disadvantage that the device heats up. Power losses of a few watts are typically expected in the holding state. For vacuum switchgears, considerably higher power losses may occur. Considering the fact that contactors or switches are mostly combined in one switch box, active measures for dissipating heat must be taken.

The use of electronics has not yet resulted in satisfactory improvement. Thus, known electronic approaches for electromagnet systems include controlling the power requirement via pulse width modulation. This method results in the need for generating increasingly narrower pulses in the circuit as power consumption decreases. As the pulses become narrower, harmonic components appear, which cause problems in electromagnetic shielding and compatibility.

A magnet system having a circuit system for generating pulse trains to regulate power consumption is presented in German Patent Application 39 10 810 A1 or in German Patent Application 195 26 038 A1, for example.

The object of the present invention is therefore to provide an electromagnet system in which the power loss in holding operation is reduced as far as possible.

This object is achieved by the features of the main claim. Improved embodiments are presented in the subclaims.

The magnet system is based on the following structure:

a main magnetic circuit formed by a preferably U-shaped magnet yoke and a magnet armature;

a contact apparatus of the switch, mechanically linked to the magnet armature, and a preferably spring-loaded magnet armature acted upon by a restoring device;

at least one permanent magnet situated in the main magnetic circuit for generating the holding force for the magnet armature; and

at least one excitation winding located on at least one pole leg, i.e., on the magnet yoke, for generating the pull-in force for the magnet armature isolated from the magnet yoke. The electromagnet system is triggered electronically by an associated circuit system.

The essence of the present invention is that, parallel to the main magnetic circuit, a shunt circuit is provided, which is also closable via the magnet armature and the shunt circuit includes the two pole legs and a second yoke arc, which is situated on the magnet yoke facing away from the pole faces and is interrupted by a remanence air gap.

Additional advantageous embodiments include the following:

The magnet system (magnet yoke, second yoke arc, and permanent magnet) is magnetically dimensioned such that the holding power—when the magnet armature is pulled in—is applied by the permanent magnet alone without the excitation winding being energized.

The permanent magnet generates a first magnetic force flux (MK1) via the pole legs and the magnet armature, and a second force flux (MK2) via the shunt circuit and the remanence flux gap. The absolute value of the two force fluxes is therefore determined by the state of charge of the permanent magnet. The ratio of the force fluxes is determined by the dimensioning of the shunt circuit (including the remanence air gap) and the distance of the magnet armature. The first magnetic force flux (MK1) is responsible for securely holding the magnet armature on the pole faces. This armature holding force counteracts the spring force which opens the magnet system when there is little or no magnetic force. In this case, the magnet armature moves to stops, which are not shown. The excess armature holding force, generated via the magnetic flux by the magnet armature, over the spring force is a measure of the sensitivity of the magnet system to external mechanical interference. A minimum magnetomotive force (lowest current through the excitation coils, depending on the number of turns per unit length) should be sufficient for opening the magnet system, whereby the first magnet flux is weakened to the point that the spring force is sufficient to lift the magnet armature. The above-mentioned low excitation current generates a magnetic flux which is opposite the flux through the magnet armature and which essentially displaces the first magnetic force flow into the shunt circuit virtually without loss.

To close the magnet system, a considerably higher excitation current is used, which is sufficient to overcome the spring force at maximum magnet armature stroke. As the magnet armature approaches the pole faces, the magnetic fluxes shift between the main and shunt flux circuits, while the magnetic energy remains constant.

The magnet yoke has a U-shaped design and has two L-shaped halves, each having a longer pole leg and a shorter cross leg, one pole leg of each half facing the contact faces of the magnet armature. The permanent magnet is clamped in the center between the cross legs without welding. The second yoke arc is parallel to the cross legs.

The remanence air gap, whose width is on the order of magnitude of 0.3 mm, may be filled with air or with a non-magnetic material.

The excitation winding of the magnet system is connected to an energy accumulator, whose energy content is sufficient for releasing the magnet armature from the holding state. The energy accumulator may be an accumulator capacitor or an inductor.

A monitoring unit for controlling the voltage state of the energy accumulator is preferably associated with the circuit system, which makes it possible to switch the system to another power source or to output an error signal.

The advantage of the present invention is that it permits a circuit system (preferably having pulse width modulation) for activating the excitation winding and delivering electric power for the excitation winding to be operated virtually in the stand-by mode.

The EMC measures may be reduced because in the holding state only the electric power for the idling power of the circuit must be provided. In comparable magnet systems, the power is cyclical in the holding state, whereby interference fields cannot be avoided. The cutout power is minimal. The holding power is low and corresponds to the standby power of the control electronics. The design of the electronics is determined only by its own power consumption. From the point of view of power, the magnetic circuit is designed only for the “close magnet armature” situation. The cutout power should preferably be ensured in the pull-in phase, for example, by charging a capacitor during the pull-in phase. As is the case in comparable systems, the permanent magnet is made of a magnetically hard material, for example, of AlNiCo, rare earth compounds being also utilizable.

The advantage of the magnet system is in particular that less space is needed for the excitation coil, permitting a more compact design.

The present invention may be used in general wherever the motion of the magnet armature is convertible into the form of a linear drive.

Further details and advantages of the present invention are derived from the following exemplary embodiment elucidated with reference to the figures.

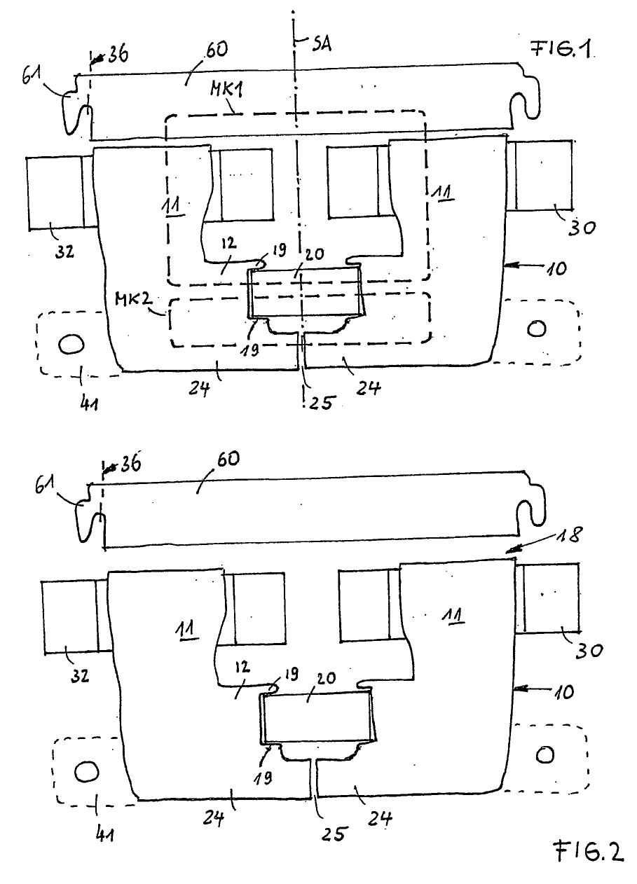

FIG. 1 shows the magnet system having a pulled-in magnet armature;

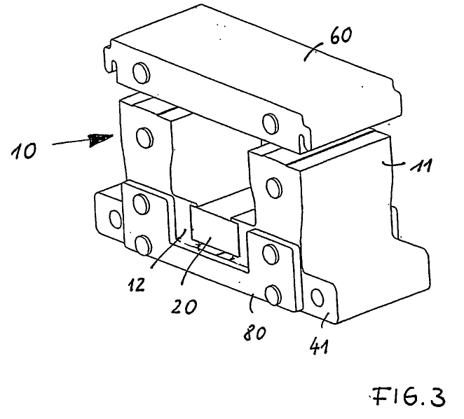

FIG. 2 shows the magnet system having a lifted magnet armature; and

FIG. 3 shows the magnet system as an assembly drawing.

Magnet yoke 10 has a U shape and has two symmetric halves (in an L shape) with respect to the vertical axis of symmetry SA with longer pole legs 11 and short cross legs 12. The cross legs are facing each other. A permanent magnet 20 is mounted between the cross legs. For this purpose, the ends of the cross legs have projections 19, between which the permanent magnet is clamped during assembly. In contrast to comparable magnet constructions, where expensive laser welding joints are used, this is an elegant and simple construction. FIG. 3 shows the assembly drawing, where it can be seen that the magnet system is made of sheet metal stacks which are riveted through cover plates 80, resulting in mechanical cohesion.

The free ends of pole legs 11 form a plane as pole faces for magnet armature 60. Magnet armature 60 is made of a plate-shaped body having lateral extensions 61. A restoring force is applied to the magnet armature, which should be preferably linearly movable, by at least one spring (36) (not shown). The magnet armature has an air gap or stroke 18. A mechanical link which exists between the magnet armature and a contact apparatus of the switch or contactor is not shown.

The magnet yoke has its usual form as a sheet metal stack. Fastening legs 41, each having a bore hole, to which the magnet system may be attached in a housing, are situated laterally, facing cross legs 12.

A magnetic shunt circuit MK2, present on magnet yoke (11, 12) facing away from the pole faces, is associated with first magnetic flux circuit MK1. The shunt circuit is formed by two second yoke arc legs 24 (parallel legs) parallel to short cross legs 12. Cross legs and yoke arc legs are separated by a groove; otherwise they are material components of the magnet yoke.

Each pole leg 11 is surrounded by bobbins having excitation windings 30, 32. The magnetic flux generatable by excitation windings 30, 32 is superimposed in the air gap on the magnetic flux of permanent magnet 20. During the pull-in operation, the two magnetic fluxes are subtracted from each other in the shunt circuit.

Yoke arc legs 24 each have a smaller cross-section compared to first cross legs 12 and the magnet armature.

However, due to its function, during the pull-in operation, the highest magnetic flux density is in the magnet armature.

The yoke arc legs are separated by a remanence air gap 25. The width of the remanence air gap is approximately 0.3 mm. The ratio of magnetic flux MK1 to magnetic flux MK2 is defined by the cross sections of the yoke arc legs and the width of the remanence air gap.

Due to its magnetic energy, the permanent magnet generates a magnetic flux, which is split into the two magnetic flux circuits MK1 and MK2. The design of the magnet system, in particular the strength of the permanent magnet, is selected such that in the holding state (magnet armature pulled in, without being acted upon by the electric excitation via coils 30, 32) the magnet armature is held securely on the magnet yoke for all operating conditions.

Using this magnetic dimensioning, no magnetic power needs to be delivered by the excitation coils in the holding position; the holding force for the magnet armature is applied by the permanent magnet alone. This preferably makes it possible to minimize the electric power of the associated electronic circuit, because essentially only the triggering power is to be provided. The low triggering power may be adequately supplied, for example, by a suitably dimensioned accumulator capacitor or an inductor whose energy content may also be monitored by the electronic circuit.

It only requires a low power to move the magnet armature from the holding position to the open position (which may mean the OFF position of a switch, for example). This power is delivered by the control electronics to excitation windings 30, 32, whose magnetic flux weakens the flux through the pole faces to the point where the holding force is overcome.

The flux pattern changes accordingly, and the major portion of the magnetic power is forced into the shunt circuit (yoke arc leg 24, remanence air gap 25). An accumulator capacitor may be used for cutout, because a power of maximum 1 Watt is sufficient for this purpose. Such a capacitor has no significant power loss, so that only an idling power on the order of magnitude of considerably less than 1 Watt must be provided in the electrical trigger circuit system in the holding state.

The magnet system is driven (closing of the magnet armature, drive excitation) by a strong coil current (e.g., 100 Watt for 100 msec.) which generates a magnetic flux opposing that of the permanent magnet in the pole legs and also overcomes the spring force at the magnet armature. As the magnet armature approaches the pole faces, the density of the magnetic field in magnetic circuit MK1 increases. Magnetic shunt circuit MK2 now only contains a low magnetic energy.

After contact of the magnet armature with the pole faces (closing), the power flow may be turned off because (as explained above), the holding force is provided statically.

What is claimed is:

1. An electromagnet system for a switch, in particular for a switch contactor, comprising:
a main magnetic circuit (MK1) formed by a magnet yoke (10) and a magnet armature (60) acted upon by a restoring device (36);
a contact apparatus of the switch, mechanically linked to the magnet armature (60);
at least one permanent magnet (20) situated in the main magnetic circuit (MK1) for generating the holding force for the magnet armature (60);
at least one excitation winding (30, 32) associated with the magnet yoke (10) for generating the pull-in force for the magnet armature (60) isolated from the magnet yoke (10); and
a circuit system for electronic triggering of the electromagnet system,
wherein, parallel to the main magnetic circuit (MK1), a shunt circuit (MK2) is provided, which is also closable via the magnet armature (60) and includes the two pole legs (11) and a yoke arc (24), which is situated on the magnet yoke (10) facing away from the pole faces and is interrupted by a remanence air gap (25).

2. The electromagnet system as recited in claim 1, wherein the magnet system is magnetically dimensioned such that the holding power—when the magnet armature (60) is pulled in—is reliably applied by the permanent magnet (20) without the excitation winding (30, 32) being energized.

3. The electromagnet system as recited in claim 1 or 2, wherein the magnet system is magnetically dimensioned such that a minimum magnetomotive force to force the magnetic power of the permanent magnet (20) into the shunt circuit (MK2) is sufficient for opening the magnet system.

4. The magnet system as recited in one of the preceding claims, wherein the magnet yoke (10) has a U-shaped design and has two L-shaped halves, each having a longer pole leg (11) and a shorter cross leg (12), one pole leg (11) of each half facing the contact faces of the magnet armature (60).

5. The magnet system as recited in one of the preceding claims, wherein the permanent magnet (20) is situated in the center between the cross legs (12).

6. The magnet system as recited in one of the preceding claims, wherein the second yoke arc (24) is parallel to the cross legs (12).

7. The magnet system as recited in one of the preceding claims, wherein the magnet system is designed as a magnetic sheet system.

8. The magnet system as recited in one of the preceding claims, wherein the remanence air gap (25) is filled with a non-magnetic material.

9. The magnet system as recited in one of the preceding claims, wherein the permanent magnet (20) is clamped between the cross legs (12).

10. The magnet system as recited in one of the preceding claims, wherein the excitation winding (30, 32) of the magnet system is connected to an energy accumulator, whose energy content is sufficient for releasing the magnet armature (60) from the holding state.

11. The magnet system as recited in claim 10, wherein the energy accumulator is an accumulator capacitor or an inductor.
